(19) United States
(12) Patent Application Publication
(10) Pub. No.: US 2007/0262121 A1
(43) Pub. Date: Nov. 15, 2007

(54) Method of soldering component to substrate and electronic device made by the same

(75) Inventors: Sinn-Wen Chen, Hsinchu City (TW); Chao-Hong Wang, Cingshuei Town (TW); Po-Yin Chen, Keelung City (TW); Zhien-Chi Chen, Tainan City (TW)

Correspondence Address: REED SMITH LLP, 3110 FAIRVIEW PARK DRIVE, SUITE 1400, FALLS CHURCH, VA, 22042, US

(73) Assignee: Darfon Electronics Corporation

(21) Appl. No.: 11/797,874

(22) Filed: May 8, 2007

(30) Foreign Application Priority Data
May 11, 2006 (TW) 95116703

(51) Int. Cl. A47J 36/02

(52) U.S. Cl. 228/101

(57) ABSTRACT

A method for soldering an electronic component to a substrate is provided. The method includes the steps of forming a metal layer on the substrate; applying a solder material on the metal layer; and performing a thermal process to transfer the solder material into a solder joint so as to connect the electronic component with the substrate. During the thermal process, a portion of the metal layer is introduced into the solder joint, thereby elevating the eutectoid temperature of the solder joint. This invention also provides an electronic device made by this method.

### CROSS REFERENCE TO RELATED APPLICATIONS

This application claims the right of priority based on Taiwan Patent Application No. 095116703 entitled “Method of Soldering Component to Substrate and Electronic Device Made by the Same,” filed on May 11, 2006, which is incorporated herein by reference and assigned to the assignee herein.

### TECHNICAL FIELD

The present invention relates to a soldering method, and more particularly to a method capable of elevating the eutectoid temperature of the solder joint and the electronic device made by the same.

### BACKGROUND OF THE INVENTION

Soldering is an important connection technique in the electronic industry. The solder material is typically a metal with low melting point and good malleability, and the tin alloy is a most common one. During the soldering process, the solder material contacts the substrate material to be connected, and usually a portion of the substrate material would dissolve into the melt and be transferred into an intermetallic phase at the interface of the melt and the substrate material to be connected.

The melting of the alloy typically has a start melting temperature and a complete melting temperature that define a temperature interval, wherein the start melting temperature is called the eutectoid temperature, and the complete melting temperature is called the liquidus temperature. During the soldering process according to the prior art, some ingredients of the substrate material may dissolve into the melt, and the eutectoid temperature or the liquidus temperature of thus formed solder joint may decrease. Take the Sn—Cu eutectic solder material with an eutectoid temperature, namely an eutectic temperature, of 227° C. as an example, the eutectoid temperature of thus formed solder joint may decrease to 217° C. as Ag in the substrate material dissolves into the solder material. Similarly, for a Sn—Ag hypoeutectic solder material with a silver content less than 3.5 wt %, the liquidus temperature of thus formed solder joint may decrease as Ag in the substrate material dissolves into the solder material. Furthermore, when a common Sb solder material of Sn-5 wt % contacts the substrate material Ag and makes Ag dissolve into the solder material, the eutectoid temperature of thus formed solder joint may decrease.

The eutectoid temperature decrease of the solder joint may have ill effects on the stage-by-stage soldering process. For example, in a two stage soldering process, the operation temperature of the second stage cannot be higher than the eutectoid temperature of the solder joint resulted from the first stage, so as to prevent the solder joint from melting. However, in the prior art mentioned above, the substrate material may dissolve into the melt and make the eutectoid temperature of the solder joint decrease. Therefore, it is not easy to control the operation temperature of the second stage soldering, and the product quality is impacted. Accordingly, it is necessary to provide a soldering method to solve problems caused in the prior art.

### SUMMARY OF THE INVENTION

To solve the problem, the present invention provides a method for forming a solder joint on a substrate. The method includes forming a metal layer on the substrate, and introducing a portion of or entire the metal layer into the melt during a thermal process to form the solder joint. The thermal process connects the substrate with an electronic component, and meanwhile, elevates the eutectoid temperature of the solder joint.

In one embodiment, the present invention provides a method for soldering an electronic component to a substrate, and the electronic component has a pin. The method includes forming a metal layer on the substrate; applying a solder material on the metal layer; performing a first thermal process to transfer the solder material into a solder joint and introduce a portion of the metal layer into the solder joint, so that an eutectoid temperature of the solder joint is higher than an eutectoid temperature of the solder material; and connecting the pin and the solder joint.

Another aspect of the present invention provides an electronic device formed by the method mentioned above. In one embodiment, the present invention provides an electronic device having a solder joint. The electronic device includes a substrate over which the solder joint located; and a metal layer between the substrate and the solder joint, contacting the solder joint. The solder joint includes a portion of the metal layer introduced during a thermal process, so that an eutectoid temperature of the solder joint is higher than an eutectoid temperature of a solder joint without the portion of the metal layer.

### BRIEF DESCRIPTION OF THE DRAWINGS

FIG. 1 to FIG. 4 are schematic diagrams illustrating the steps of a thermal process and a soldering process for a substrate and an electronic component of a circuit board according to the present invention.

### DETAILED DESCRIPTION OF THE PREFERRED EMBODIMENTS

The preferred embodiments of the present invention would be illustrated below referring to the attached drawings. It should be noted that, to present the invention clearly, the layers and the elements in the attached drawings are not depicted to scale, and the following description would omit well-known components, materials and process techniques for avoiding obscuring the present invention.

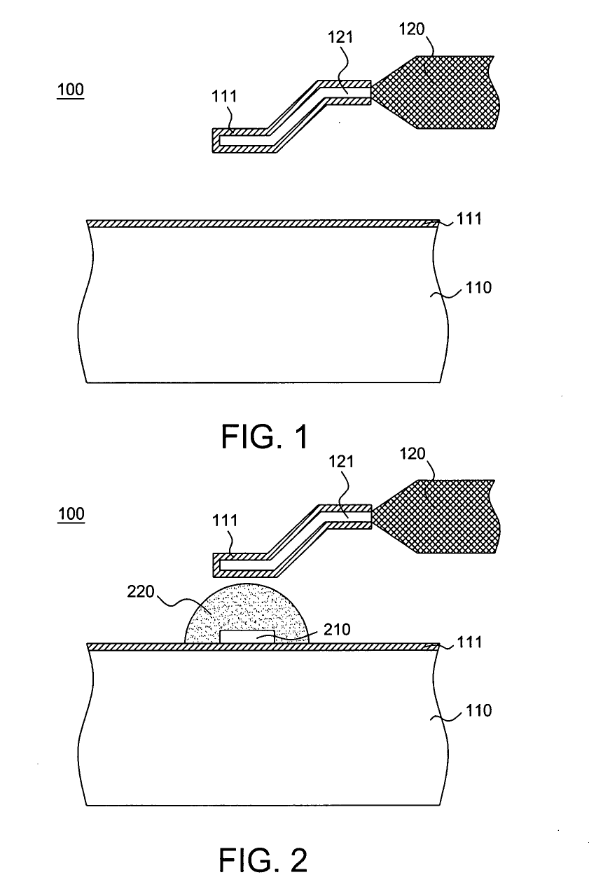

FIG. 1 to FIG. 4 illustrate a method for soldering an electronic component to a substrate to form an electronic device according to the present invention. This illustration takes a circuit board as a preferred embodiment of the electronic device. As shown in FIG. 1, a circuit board 100 is provided. The circuit board 100 includes a substrate 110 and an electronic component 120 to be connected to the substrate 110. The substrate 110 typically has a pattern or a line consisted of metal (not shown). A surface treatment layer 111 may be included on the substrate 110 on demand, serving as a barrier layer for preventing the solder material from overreacting with the surface of the substrate 110, or a wetting layer for wetting the solder material/substrate 110 interface. Typical materials of the surface treatment layer are Au, Cu, Ni, Pd, or their combinations. The electronic component 120 may be a resistor, a capacitor, or an IC chip, and includes a pin 121 preferably made of metal. Similarly, a surface treatment layer 111 may be applied to the surface of the pin 121 on demand.

Next, as shown in FIG. 2, a metal layer 210 is formed on the substrate 110, preferably by electroplating. Then a solder material 220 is applied on the substrate 110 and contacts with the metal layer 210. It should be noted that, the composition of the metal layer 210 should match the solder material 220 to elevate the eutectoid temperature of the solder joint to be formed. For example, the metal layer 210 may preferably be made of Sn as the solder material 220 includes Sn and Sb. Alternatively, the metal layer 210 may preferably be made of Te as the solder material 220 includes Se. Besides, persons skilled in the art would understand that the solder flux, the surfactant or other ingredients may be added into the solder material 220 on demand.

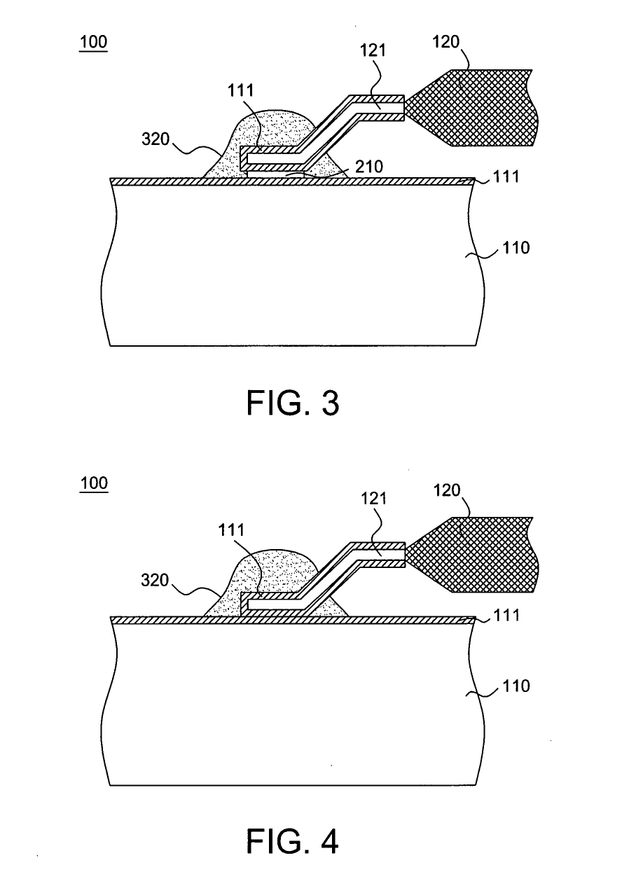

Next, as shown in FIG. 3 and FIG. 4, a first thermal process and a first soldering process are proceeded to transfer the solder material 220 into the solder joint 320 connecting the pin 121 with the substrate 110. And a portion of or entire the metal layer 210 is introduced into the solder joint 320 to make the eutectoid temperature of the solder joint 320 higher than the eutectoid temperature of the solder material 220. Furthermore, through the solder joint 320 connecting the pin 121 with the substrate 110, the metal patterns or lines on the substrate 110 are electrically connected to the pin 121. As shown in FIG. 3, there is a remaining metal layer 210 on the substrate 110, which indicates only a portion of the metal layer 210 is introduced into the solder joint 320. As to FIG. 4, there is no metal layer 210 on the substrate 110, which indicates the entire metal layer 210 is introduced into the solder joint 320. Additionally, it should be noted that the method of the present invention may not induce the intermetallic phase of the solder material 220/substrate 110 interface, and the metal layer 210 is kept at the solid solution phase.

After the first thermal process and the first soldering process mentioned above, a second thermal process and a second soldering process may be performed on demand. As discussed above, the operation temperature of the second thermal process should be carefully controlled to prevent the solder joint 320 formed in the first thermal process from melting. Since the present invention elevates the eutectoid temperature of the solder joint 320 formed in the first thermal process to be higher than the eutectoid temperature of the solder material 220, the eutectoid temperature decrease in the prior art would not occur. Thus the operation temperature of the second thermal process could be precisely held below the eutectoid temperature of the solder material 220. In other words, an advantage of the present invention lies in the easy control of the operation temperature of the second thermal process.

In addition, the eutectoid temperature of the solder joint 320 may be elevated to be higher than the liquidus temperature of the solder material 220 by adjusting the composition of the metal layer 210. Therefore, the operation temperature of the second thermal process may have a broader range, which brings another advantage of the present invention.

Non-limiting embodiments of eutectoid temperature elevation of the present invention are provided below.

### Embodiment 1

200 mg of Sb solder material with Sn-5 wt % is placed on a pure Sb slice and sealed as a whole in a quartz tube with an inner diameter of 3 mm and an outer diameter of 4 mm. This embodiment is heated to 265° C. and kept for 5 minutes by a differential thermal analysis (DTA) equipment, then cooled to room temperature, and the melting temperature interval is observed and measured. Next, the heating, keeping, cooling, observation and measurement mentioned above are repeated. The temperature intervals obtained by the two measurements are 240° C., 244° C. and 250° C., 257° C. respectively. It could be found that the eutectic temperature has been elevated from 240° C. to 250° C., and the liquidus temperature has been elevated from 244° C. to 257° C.

### Embodiment 2

A Sb layer with a thickness of 50 μm is electroplated on an Ag substrate with a thickness of 500 μm. A Sb solder material with Sn-5 wt % is placed on the Sb layer on the substrate and reflowed at 260° C. to form a solder joint. Next, the substrate with the solder joint is placed at 244° C. and observed for 1 hour. No melting occurs.

### Embodiment 3

An Ag layer with a thickness of 100 μm is electroplated on a Si substrate, and then a Sb layer with a thickness of 50 μm is electroplated on the Ag layer. A Sb solder material with Sn-5 wt % is placed on the Sb layer on the substrate and reflowed at 260° C. to form a solder joint. Next, the substrate with the solder joint is placed at 244° C. and observed for 1 hour. No melting occurs.

### Embodiment 4

500 mg of Se metal particles are placed on a pure Te slice and sealed as a whole in a quartz tube with an inner diameter of 3 mm and an outer diameter of 4 mm. This embodiment is heated to 225° C. and kept for 5 minutes by a differential thermal analysis equipment, then cooled to room temperature, and the melting point is observed and measured (Se metal particles has no temperature interval since they are not alloy). Next, the heating, keeping, cooling, observation and measurement mentioned above are repeated. The melting point/temperature interval obtained by the two measurements are 221° C. (namely the melting point of Se) and 225° C., 232° C. respectively. The temperature interval 225° C.-232° C. obtained by the second measurement indicates that a potion of Te melted into Se, and the eutectic temperature is elevated from 221° C. to 225° C.

### Embodiment 5

200 mg of Se metal particles are placed on a pure Te substrate and reflowed at 260° C. to form a solder joint. Next, the substrate with the solder joint is placed at 221° C. and observed for 1 hour. No melting occurs.

The method of the present invention applies to any electronic devices that need soldering to form interconnections between its components and the substrate. FIG. 1 to FIG. 4 illustrate the method of the invention with a circuit board as an example of the electronic device, however, it should be noted that the electronic devices herein are not limited to the circuit boards.

It should be noted that the method of the present invention does not utilize an alloy solder material containing the kind of metal employed in the present invention directly. Since if this kind of alloy solder material is directly utilized, the process temperature would certainly be elevated. In other words, according to the present invention, the appropriate process temperature of the first thermal process depends on the ingredients of the solder material but not on the temperature to be elevated to. As shown in FIG. 3, the dissolution of the metal layer 220 into the melt occurs after the wetting of the substrate 110. At this time, the interface between the solder material 220 and the substrate 110 has been formed, and the elevation of the melting point of the melt would not influence the thermal process.

The above description is only for preferred embodiments, but not to limit the scope of the present invention. Any other equivalent changes or modifications performed within the spirit disclosed by the present invention should be included in the appended claims.

We claim:

1. A method for forming a solder joint on a substrate, comprising:
forming a metal layer on said substrate;
applying a solder material on said metal layer; and
performing a first thermal process to transfer said solder material into said solder joint and introduce a portion of said metal layer into said solder joint, so that an eutectoid temperature of said solder joint is higher than an eutectoid temperature of said solder material.

2. The method according to claim 1, further comprising forming a surface treatment layer between said substrate and said metal layer.

3. The method according to claim 2, wherein a material of said surface treatment layer is selected from the group consisting of Au, Cu, Ni, Pd, and their combinations.

4. The method according to claim 1, wherein said eutectoid temperature of said solder joint is higher than a liquidus temperature of said solder material.

5. The method according to claim 1, wherein a liquidus temperature of said solder joint is higher than a liquidus temperature of said solder material.

6. The method according to claim 1, wherein said solder material comprises Sn and Sb, and said metal layer comprises Sb.

7. The method according to claim 6, wherein a Sb content of said solder material is 5 wt % of a Sn and Sb total content of said solder material.

8. The method according to claim 1, wherein said solder material comprises Se, and said metal layer comprises Te.

9. The method according to claim 1, further comprising setting said substrate at said eutectoid temperature of said solder material, and performing a second thermal process without melting said solder joint.

10. The method according to claim 1, further comprising setting said substrate at a liquidus temperature of said solder material, and performing a second thermal process without melting said solder joint.

11. The method according to claim 1, wherein said step of forming said metal layer on said substrate is electroplating said metal layer on said substrate.

12. The method according to claim 1, wherein said step of performing said first thermal process is performed at a temperature higher than said eutectoid temperature of said solder material.

13. The method according to claim 1, further comprising:
connecting a pin of an electronic component with said solder joint.

14. An electronic device having a solder joint, comprising:
a substrate, said solder joint being over said substrate; and
a metal layer between said substrate and said solder joint, said metal layer contacting said solder joint;
wherein said solder joint comprises a portion of said metal layer introduced during a thermal process, so that an eutectoid temperature of said solder joint is higher than an eutectoid temperature of a solder joint without said portion of said metal layer.

15. The electronic device according to claim 14, wherein a liquidus temperature of said solder joint is higher than a liquidus temperature of a solder joint without said portion of said metal layer.

16. The electronic device according to claim 14, wherein said solder joint comprises Sn and Sb, and said metal layer comprises Sb.

17. The electronic device according to claim 14, wherein said solder joint comprises Se, and said metal layer comprises Te.

18. The electronic device according to claim 14, further comprising a surface treatment layer between said substrate and said metal layer.

19. The electronic device according to claim 18, wherein a material of said surface treatment layer is selected from the group consisting of Au, Cu, Ni, Pd, and their combinations.

20. The electronic device according to claim 14, wherein said electronic device is a circuit board, said circuit board further comprises an electronic component having a pin, and said pin is connected to said substrate through said solder joint.
